(19) United States
(12) Patent Application Publication
(10) Pub. No.: US 2010/0091013 A1
(43) Pub. Date: Apr. 15, 2010

(54) METHOD FOR PROVIDING SERVICE ABOUT MAKING CONTENTS AND THREE-DIMENSIONAL ANIMATION

(76) Inventors: Sung-Jun Park, Seoul (KR); Sung-Do Lee, Seoul (KR)

Correspondence Address: SHERIDAN ROSS PC, 1560 BROADWAY, SUITE 1200, DENVER, CO, 80202, US

(21) Appl. No.: 12/444,454

(22) PCT Filed: Apr. 2, 2008
(86) PCT No.: PCT/KR08/01843

§ 371 Date: Apr. 6, 2009

(30) Foreign Application Priority Data
Apr. 4, 2007 (KR) 1020070033227

(51) Int. Cl. G06T 15/00; G06F 15/16

(52) U.S. Cl. 345/419; 709/219

(57) ABSTRACT

A contents server for providing a contents creating service is disclosed. When the contents server receives a request for first contents from a terminal, it provides the first contents to the terminal. When the contents server receives second contents using the first contents from the terminal, it gives a point to a producer of the first contents. Thus, contents of a different person can be easily used for creating contents, and a producer of used contents can be properly compensated.

### TECHNICAL FIELD

The present invention relates to a method for providing a service for producing three-dimensional (3D) animation and contents.

### BACKGROUND ART

In a process of producing (creating) digital contents, contents that have been already produced by a different producer (i.e., creator, maker, etc.) are used in many cases. Namely, if a single digital content is combined with a plurality of contents and new content is added thereto so as to be produced, the manufacturing term would be shortened, and more substantial, useful, and rich contents can be produced.

However, it is not easy to search contents produced by other producers.

In addition, it is difficult to recognize an original producer when using different contents, causing a problem in that it is difficult to pay a proper price to the original producer.

Moreover, it is not easy to take action against unauthorized use of contents of a person by someone else.

In particular, recently, as UCC (user created contents), video products have draws much attention, videos are being actively created. Generally, users create video by recording original video by using a recording device such as a camcorder, etc., and then use video editing software. While videos produced by such creating process is mainstream video contents, 3D animation creation activities for creating 3D animation by using 3D models in a 3D virtual space are gradually spreading. Because the 3D animation is created in a virtual space, it is advantageous in that there is no limitation in expressing astrospace, the undersea world, animal and plant characters, etc. However, manufacturing of 3D animation by a user alone from the beginning to end requires much time and effort, so such creating process needs to be improved.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a method for providing a contents producing service having advantages of protecting the rights of contents producers and easily using contents of others.

### Technical Solution

An exemplary embodiment of the present invention provides a server for providing a contents creating (producing) service, which receives a request for first contents from a terminal, provides the first contents to the terminal, receives second contents using the first contents from the terminal, and when the second contents are received, the server gives a point to a producer of the first contents.

In this case, the server may give a point to the producer of the first contents when providing the first contents to the terminal. The server may give a point to the first contents when providing the first contents to the terminal. The server may give a point to the first contents when receiving the second contents.

Another embodiment of the present invention provides a server for providing a contents creating service, which receives a request for a source file of first contents from a terminal, provides the source file of the first contents to the terminal, receives a source file and a reproduction file of second contents using the first contents from the terminal, and adds link information of the first contents to a Web page for the second contents. In this case, the server may add link information of the second contents to a Web page for the first contents.

Yet another embodiment of the present invention provides a server for providing a 3D animation producing service, which receives a request for a reproduction file of a first animation from a terminal, provides a reproduction file of the first animation to the terminal, receives a request for an origination file of the first animation from the terminal, provides the source file of the first animation to the terminal, receives a source file and a reproduction file of the second animation using the first animation from the terminal, and gives a point to a producer of the first animation.

Still another embodiment of the present invention provides an authoring tool that receives a source file of first contents from a server, generates a source file of second contents by using the source file of the first contents, generates a reproduction file of the second contents by rendering the source file of the second contents, and transmits the source file of the second contents and the reproduction file of the second contents to the server.

In this case, the authoring tool may generate the reproduction file of the second contents by including a usage relationship with respect to the first contents.

### Advantageous Effect

According to an exemplary embodiment of the present invention, because creative works of other producers can be easily searched and used, creating works can be effectively conducted and achieved.

In addition, if a different person uses contents of a user to produce new contents, the user can win renown or can be paid, so desires for creating high level contents can be increased and manufacturing of contents can be activated among the contents producers.

### DESCRIPTION OF DRAWINGS

FIG. 1 is a drawing illustrating a three-dimensional (3D) animation producing system according to an exemplary embodiment of the present invention.

FIG. 2 is a flowchart illustrating a method for producing 3D animation according to a first exemplary embodiment of the present invention.

FIG. 3 is a flowchart illustrating a method for producing 3D animation according to a second exemplary embodiment of the present invention.

FIG. 4 is a drawing illustrating a 3D animation providing Web page according to an exemplary embodiment of the present invention.

FIG. 5 is a drawing illustrating a portion of a Web page for reproducing a 3D animation according to an exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, In addition, unless explicitly described to the contrary, the word “comprise” and variations such as “comprises” or “comprising” will be understood to imply the inclusion of stated elements but not the exclusion of any other elements. Terms such as “part”, “unit”, etc., presented in the following disclosure may refer to a unit for processing at least one function or operation, which may be implemented as software, hardware, or a combination of hardware and software.

Terms used in the present invention will now be described.

A source file refers to a file that can be edited through text or a graphic user interface, etc., in an authoring tool, and turns to a reproduction file when rendered.

The reproduction file refers to a file that can be reproduced by a reproducing program such as a media player, etc. The reproduction file can be generated by rendering a source file. The authoring tool serves to convert a source file into a reproduction file.

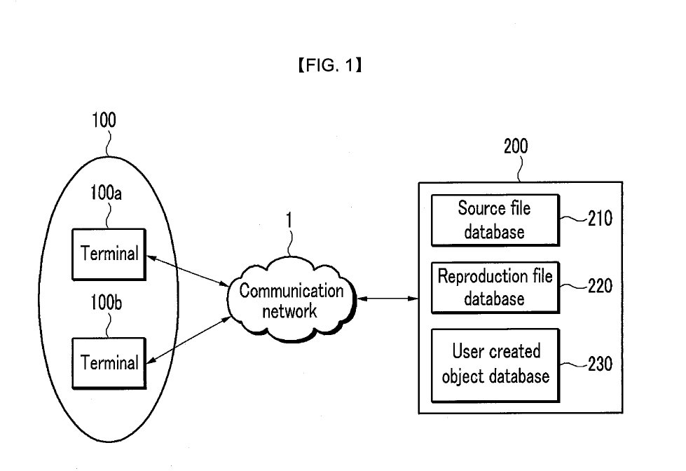

A three-dimensional (3D) animation producing system according to an exemplary embodiment of the present invention will now be described with reference to FIG. 1.

FIG. 1 is a drawing illustrating a three-dimensional (3D) animation producing system according to an exemplary embodiment of the present invention.

As shown in FIG. 1, the 3D animation producing system includes a plurality of terminals including a terminal 100a and a terminal 100b, a communication network 1, and an animation server 200.

The plurality of terminals 100a and 100b are connected to the animation server 200 via the communication network 1, and receive a 3D animation producing service from the animation server 200. The terminals 100a and 100b may be a notebook, a personal computer, etc.

The communication network 1 provides connection to the plurality of terminals 100a and 100b and the animation server 200, and may include the Internet, etc.

The animation server 200 provides the 3D animation producing service to the plurality of terminals 100a and 100b. The animation server 200 includes a source file database 210, a reproduction file database 220, and a user created object database 230.

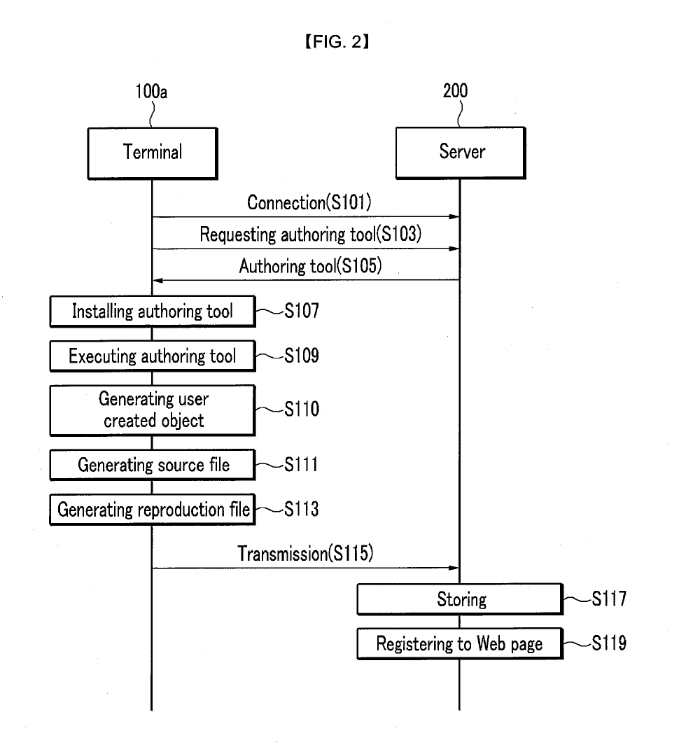

A 3D animation producing method according to a first exemplary embodiment of the present invention will now be described with reference to FIG. 2.

FIG. 2 is a flowchart illustrating a method for producing 3D animation according to a first exemplary embodiment of the present invention.

First, the terminal 100a connects to an animation server 200 (S101).

Next, the terminal 100a requests an authoring tool 10 from the animation server 200 (S103), receives the authoring tool 10 (S105), installs the received authoring tool 10 (S107), and executes the installed authoring tool 10 (S109). If the authoring tool 10 has already been installed in the terminal 100a, the steps S103, S105, and S107 may be omitted.

The authoring tool 10 generates a user created object through operations by a producer using the terminal 100a. Here, the user created object refers to a 3D model such as an animation character, an object, a background, etc., created by the user, and a material used for producing 3D animation such as music or an image. The user created object may be made by using software other than the authoring tool 10.

The authoring tool 10 receives authoring information for 3D animation from a producer using the terminal 100a and generates a source file of 3D animation (S111). In this case, the source file of the 3D animation includes information for identifying the producer.

When the source file of the 3D animation is completed, the authoring tool 10 renders the source file of the 3D animation to generate a reproduction file of the 3D animation (S113).

Thereafter, the authoring tool 10 transmits the source file of the 3D animation and the reproduction file of the 3D animation to the animation server 200 (S115). In this case, the authoring tool 10 inquires of the producer about whether to transmit the user created object used for producing the 3D animation desired to be transmitted, and when an approval input is received from the producer, the authoring tool 10 transmits the user created object to the animation server 200. If, however, the authoring tool 10 receives a refusal input from the producer, it does not transmit the user created object to the animation server 200.

The animation server 200 stores the source file of the 3D animation in the source file database 210, and stores the reproduction file of the 3D animation in the reproduction file database 220 (S117). Further, when the animation server 200 receives the user created object used for producing the 3D animation, it stores the user created object in the user created object database 230.

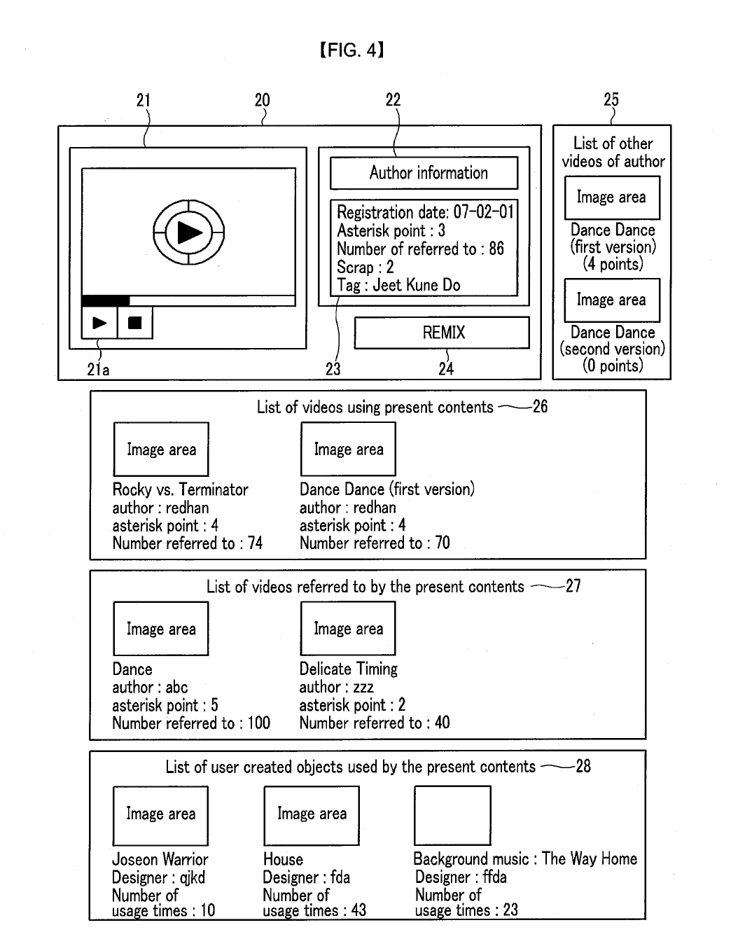

Further, the animation server registers link information of the received source file and the reproduction file of the 3D animation in a video providing Web page 20 as shown in FIG. 4 (S119).

FIG. 4 is a drawing illustrating the video providing Web page according to an exemplary embodiment of the present invention.

As shown in FIG. 4, the video providing Web page 20 includes a video reproducing screen 21, producer information 22, video information 23, a “REMIX” button 24, a list of other videos of the producer 25, a list of videos using present contents 26, and a list of videos referred to by the present contents 27.

That is, the animation server 200 registers the received reproduction file of the 3D animation to a video reproducing screen 21 of the video providing Web page 20, and registers the producer information of the 3D animation at the producer information 22 of the video providing Web page 20. Further, the animation server 200 registers association information of the received 3D animation in the video information 23 of the video providing Web page 20, and registers the link information of the source file of the received 3D animation to the REMIX button 24.

A 3D animation producing method according to a second exemplary embodiment of the present invention will now be described.

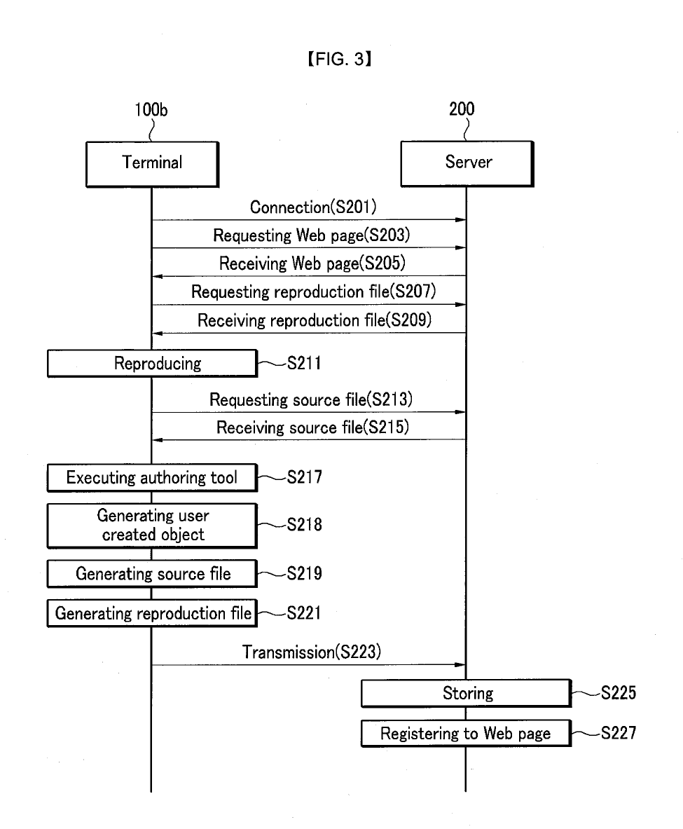

FIG. 3 is a flowchart illustrating a method for producing 3D animation according to a second exemplary embodiment of the present invention.

The second embodiment of the present invention will be described in view of the terminal 100b, not the terminal 100a, with reference to FIG. 3. It is assumed that the authoring tool 10 has been already installed in the terminal 100b through the steps S103, S105, and S107.

First, the terminal 100b connects to the animation server 200 (S201).

Thereafter, the terminal 100b requests the video providing Web page 20 from the animation server 200 and receives the video providing Web page 20 as shown in FIG. 4 (S205).

Description of FIG. 3 now continues.

If a user of the terminal 100b clicks a “video reproducing” button 21a, the terminal 100b requests a reproduction file of corresponding 3D animation from the animation server 200 (S207).

Upon receiving the request of a reproduction file of the 3D animation, the animation server 200 transmits the reproduction file of the corresponding 3D animation to the terminal 100b (S209). In this case, the animation server 200 may give a point to the transmitted 3D animation. Further, the animation server 200 may give a point to a producer of the transmitted 3D animation. The given point is displayed on the Web page.

When the terminal 100b receives the reproduction file of the 3D animation, it reproduces the reproduction file via the video reproducing screen 21 (S211).

In this case, the user of the terminal 100b may desire to create a new 3D animation by making some corrections to the reproduced 3D animation. If the user of the terminal 100b clicks the REMIX button 24 corresponding to the 3D animation desired to be corrected, the terminal 100b requests the source file of the corresponding 3D animation from the animation server 200 (S213).

Upon receiving the request for the source file of the 3D animation, the animation server 200 transmits the source file of the 3D animation to the terminal 100b (S215). In this case, the animation server 200 may transmit the user created object related to the corresponding 3D animation together with the source file to the terminal 100b. Further, the animation server 200 may give a point to the transmitted 3D animation. Further, the animation server 200 may give a point to the producer of the transmitted 3D animation. In addition, the animation server 200 may give a point to the transmitted user created object and to its producer. The given points are displayed on the Web page.

When the terminal 100b receives the source file of the 3D animation, the terminal 100b executes the authoring tool 10 and provides a correction authority of the source file of the 3D animation to the user of the terminal 100b (S217). The terminal 100b may provide the correction authority of the received user created object to the user of the terminal 100b.

The authoring tool 10 receives correction information of the user created object from the user of the terminal 100b and generates a corrected user created object (S218). The authoring tool 10 may generate a new user created object according to an operation of the user. Such generation of the user created object is not a requisite for the manufacturing of the 3D animation.

The authoring tool 10 receives the correction information with respect to the source file of the 3D animation desired to be corrected from the producer using the terminal 100b, and generates a source file of the corrected 3D animation (S219). In this case, the source file of the corrected 3D animation may include information for identifying the producer of the corrected 3D animation. The authoring tool 10 may generate a source file of the corrected 3D animation by further using a previously produced user created object or the user created object generated in step S218.

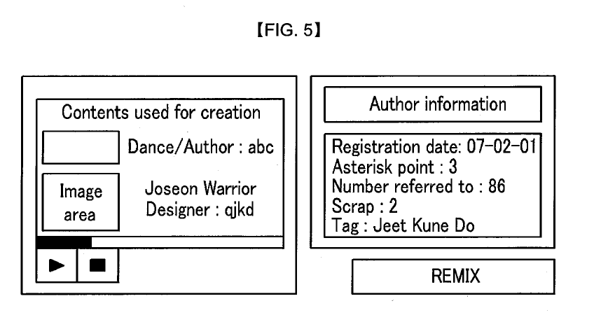

When the source file of the corrected 3D animation is completed, the authoring tool 10 renders the source file of the corrected 3D animation to generate a reproduction file of the corrected 3D animation (S221). In this case, the authoring tool 10 may add information about a list of contents (3D animation or user created object) used by the corrected 3D animation to a rear portion of the reproduction file, as shown in FIG. 5.

Thereafter, the authoring tool 10 transmits the reproduction file of the corrected 3D animation to the animation server 200 (S223). In this case, the authoring tool 10 may transmit the source file of the corrected 3D animation to the animation server 200 according to a service rule or a user determination. Further, the authoring tool 10 may transmit the corrected user created object and the newly produced user created object to the animation server 200 according to a user selection.

The animation server 200 stores the source file of the corrected 3D animation in the source file database 210 and the reproduction file of the corrected 3D animation in the reproduction file database 220 (S225). When the animation server 200 receives the user created object that has been used for producing the 3D animation, it stores the received user created object in the user created object database 230.

Further, the animation server 200 registers the information of the corrected 3D animation to the Web page of the corrected 3D animation (S227). In this case, the animation server 200 adds the link information of the 3D animation used by the corrected 3D animation as a reference relation to the “list of the videos referred to by the present contents 27” of the Web page of the corrected 3D animation. The animation server 200 adds the link information of the user created objects used by the corrected 3D animation as a reference relation to a “list of user created objects used by the present contents 28” of the Web page of the corrected 3D animation.

Further, the animation server 200 adds the link information of the corrected 3D animation as a reference relation to the “list of videos using the present contents 26” of the Web page of the 3D animation used by the corrected 3D animation.

When the animation server 200 receives the source file and the reproduction file of the corrected 3D animation, it gives a point to a relevant producer of the 3D animation that has used the corrected 3D animation (S229). Here, the relevant producer refers to producers who have contributed to creation of the 3D animation used by the corrected 3D animation. Further, when the animation server 200 receives the source file and the reproduction file of the corrected 3D animation, it may also give a point to the 3D animation used by the corrected 3D animation

Further, the animation server 200 may give a point to the user created object used by the corrected 3D animation and its producer. The given points are displayed on the Web page.

The exemplary embodiment of the present invention has been described for the 3D animation, but it can be also extended to other contents such as music, images, or the like.

The exemplary embodiments of the present invention are not implemented only according to the above-described device and/or method, but can be implemented through a program for realizing functions corresponding to the configuration of the exemplary embodiments of the present invention and a recording medium having the program stored thereon. Such implementation can be easily made by a skilled person in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for providing a contents creating service by a contents creating server, the method comprising:
receiving a request for first contents from a terminal;
providing the first contents to the terminal; receiving second contents using the first contents from the terminal; and
giving a point to a producer of the first contents when the second contents are received.

2. The method of claim 1, further comprising giving a point to the producer of the first contents when the first contents are provided to the terminal.

3. The method of claim 2, further comprising giving a point to the first contents when the first contents are provided to the terminal.

4. The method of claim 3, further comprising giving a point to the first contents when the second contents are received.

5. The method of claim 1, further comprising adding link information of the first contents to a Web page for the second contents.

6. The method of claim 5, further comprising adding link information of the second contents to a Web page for the first contents.

7. The method of claim 6, wherein the receiving of the request for the first contents comprises receiving a request for a source file of the first contents, the providing of the first contents comprises providing the source file of the first contents, and the receiving of the second contents comprises receiving a source file of the second contents and receiving a reproduction file of the second contents.

8. The method of claim 7, further comprising:
receiving a request for a reproduction file of the first contents from the terminal; and
providing the reproduction file of the first contents to the terminal.

9. The method of claim 8, further comprising:
receiving a request for an authoring tool for converting the source file to the reproduction file from the terminal; and providing the authoring tool to the terminal.

10. A method for providing a contents creating service by a contents creating server, the method comprising:
receiving a request for a source file of first contents from a terminal;
providing the source file of the first contents to the terminal;
receiving a source file and a reproduction file of second contents using the first contents from the terminal; and
adding link information of the first contents to a Web page for the second contents.

11. The method of claim 10, further comprising adding link information of the second contents to a Web page for the first contents.

12. A method for providing a three-dimensional animation producing service by an animation producing server, the method comprising:
receiving a request for a reproduction file of first animation from a terminal;
providing the reproduction file of the first animation to the terminal;
receiving a request for a source file of the first animation from the terminal;
providing the source file of the first animation to the terminal;
receiving a source file and a reproduction file of second animation using the first animation from the terminal; and
giving a point to a producer of the first animation.

13. The method of claim 12, further comprising:
adding link information of the first animation to a Web page for the second animation; and
adding link information of the second animation to a Web page for the first animation.

14. The method of claim 13, wherein the providing of the source file of the first animation comprises providing a user created object used by the first animation, wherein the second animation is animation using the first animation and the user created object.

15. The method of claim 14, further comprising giving a point to a producer of the user created object if the user created object is provided.

16. The method of claim 14, further comprising giving a point to the user created object if the user created object is provided.

17. A computer-readable recording medium having a program for realizing in a computer, comprising:
a function for receiving a source file of first contents from a server;
a function for generating a source file of second contents by using the source file of the first contents;
a function for rendering the source file of the second contents to generate a reproduction file of the second contents; and
a function for transmitting the source file and the reproduction file of the second contents to the server.

18. The medium of claim 17, wherein the function of generating the reproduction file of the second contents comprises a function of generating the reproduction file of the second contents by including a usage relationship with respect to the first contents.
